(19) United States
(12) Patent Application Publication
(10) Pub. No.: US 2008/0188273 A1
(43) Pub. Date: Aug. 7, 2008

(54) Apparatus and method for automatic sound control and portable terminal using the same

(75) Inventor: Byeong Gyun You, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 12/012,536

(22) Filed: Feb. 4, 2008

(30) Foreign Application Priority Data
Feb. 7, 2007 (KR) 2007-0012584

(51) Int. Cl. H04M 1/03

(52) U.S. Cl. 455/575.3; 455/550.1

(57) ABSTRACT

An apparatus and method for automatic sound control and a portable terminal using the same are disclosed. The automatic sound control method includes detecting a change in an operation of a portable terminal upon reproduction of an audio file, correcting an audio file according to the change in the operation of the portable terminal, and outputting the corrected audio file.

### CLAIMS OF PRIORITY

This application claims priority to an application entitled “APPARATUS AND METHOD FOR AUTOMATIC SOUND CONTROL AND PORTABLE TERMINAL USING THE SAME,” filed in the Korean Intellectual Property Office on Feb. 7, 2007 and assigned Serial No. 2007-0012584, the contents of which are incorporated herein by reference.

### BACKGROUND OF THE INVENTION

1. Field of the Invention

The present invention relates generally to an apparatus and method for automatic sound control and a portable terminal using the same, and more particularly, to an apparatus and method which can automatically control an audio signal output of a speaker depending on a change in the state of the portable terminal.

2. Description of the Related Art

In general, mobile communication systems provide various services including a short message service, a multimedia message service (MMS), a moving-image mail service, and voice communication. Recently, the use of an MPEG Audio Layer-3 (MP3) portable terminal, in which a portable terminal and an MP3 function are combined, is being popularized. As described above, a portable terminal capable of providing an MP3 function will be improved in future yield a higher-quality audio reproduction capability.

The conventional portable terminals have various characteristics depending on the sizes and shapes thereof in their audio reproduction capabilities. Especially, when a speaker unit is replaced by another component or another outer device of the portable terminal, the sound reproduced even from a high-quality sound source may deteriorate.

### SUMMARY OF THE INVENTION

The present invention has been made in view of the above problems and provides additional advantages, by providing an apparatus and method for providing an automatic sound control and a portable terminal using the same, which can properly output an audio signal regardless of the external shape of the portable terminal and the location of a speaker.

In accordance with an aspect of the present invention, an automatic sound control method includes: detecting a change in an operation of a portable terminal upon a reproduction of an audio file; correcting an audio file according to the change in the operation of the portable terminal; and outputting the corrected audio file.

In accordance with another aspect of the present invention, an automatic sound control apparatus includes: a terminal-state sensing unit for detecting a change in the operation of a portable terminal; a controller for setting different sound source correction data depending on the change in the operation; and an audio processing unit for applying the sound source correction data to the audio file and outputting the audio file.

In accordance with still another aspect of the present invention, a portable terminal includes: a memory for storing an audio file; a speaker for reproducing and outputting the audio file; a controller for controlling the audio file to be reproduced and output; one side portion including at least one of the memory, the speaker, and the controller; and another side portion including one or more components except for the at least one of the memory, the speaker, and the controller, the another side portion having at least a predetermined area facing the one side portion, wherein the speaker applies different sound source correction data to the audio file depending on the change in the facing area between the two side portions.

### BRIEF DESCRIPTION OF THE DRAWINGS

The above features and advantages of the present invention will be more apparent from the following detailed description in conjunction with the accompanying drawings, in which:

FIGS. 1A to 1F are views illustrating a portable terminal having an automatic sound control function according to an embodiment of the present invention;

FIG. 2 is a block diagram schematically illustrating the configuration of the portable terminal according to an embodiment of the present invention;

FIG. 3 is a block diagram illustrating the construction of an automatic sound control apparatus according to an embodiment of the present invention;

FIGS. 4A and 4B illustrate examples of tables to which a sound-source adjusting unit according to the present invention refers;

FIG. 5 is a flowchart illustrating an automatic sound control method according to an embodiment of the present invention;

FIGS. 6A and 6B are views illustrating the appearance of another portable terminal to which the automatic sound control method of the present invention can be applied;

FIGS. 7A and 7B are views illustrating a connection between a portable terminal and a peripheral device thereof, to which the automatic sound control method of the present invention can be applied; and

FIGS. 8A and 8B illustrate examples of tables which include bass boost setting values according to connection with a peripheral device.

### DETAILED DESCRIPTION OF THE INVENTION

Hereinafter, embodiments of the present invention are described in detail with reference to the accompanying drawings. For the purposes of clarity and simplicity, detailed descriptions of constructions or processes known in the art may be omitted to avoid obscuring the invention in unnecessary detail.

It should be clearly understood that the present invention can be applied to all information communication devices and multimedia devices, which include a mobile terminal, a mobile telephone, wired/wireless telephones, a personal digital assistant (PDA), a smart phone, an International Mobile Telecommunication 2000 (IMT-2000) terminal, a Universal Mobile Telecommunication Service (UMTS) terminal, a Global System for Mobile Communication (GSM) terminal, a DMB terminal, a notebook, etc., and also to applications thereof.

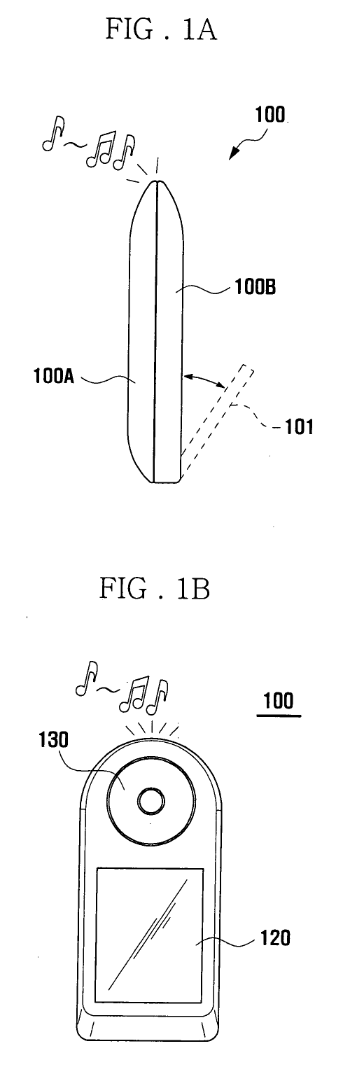

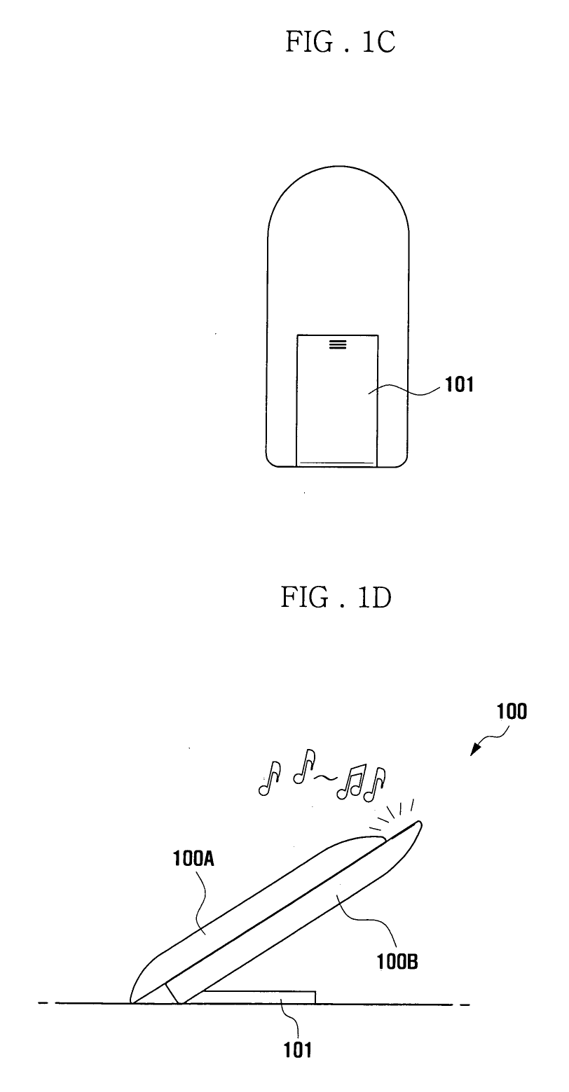

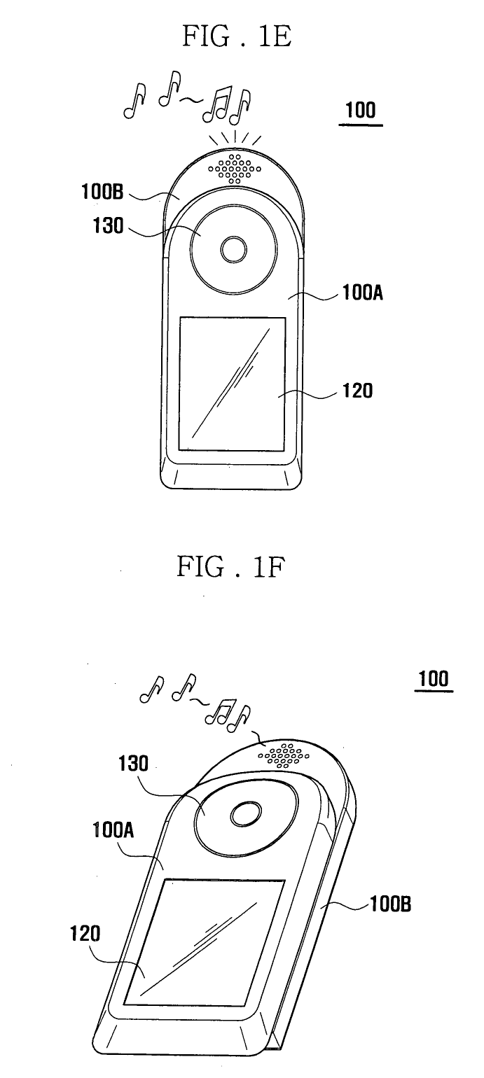

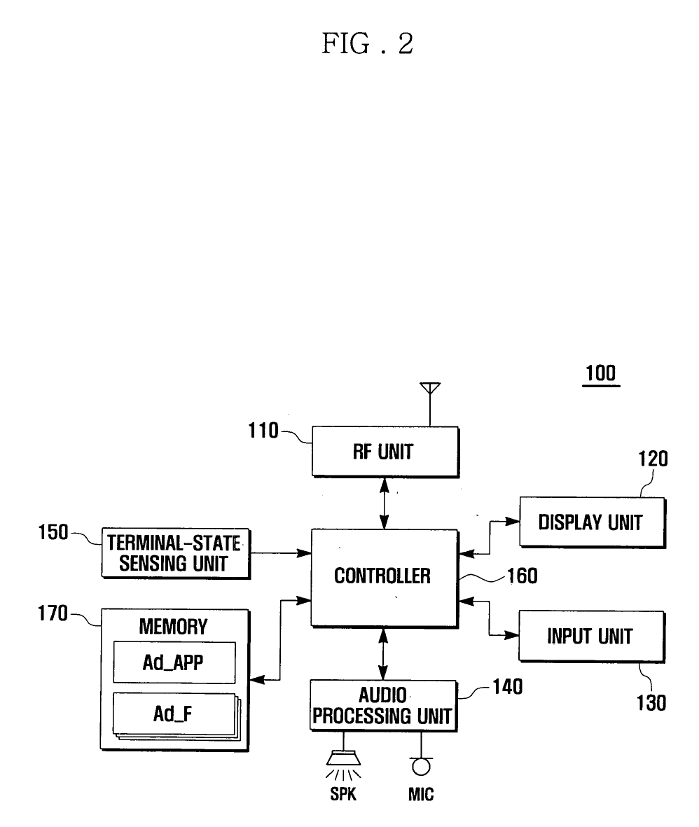

FIGS. 1A to 1F illustrate a portable terminal having an automatic sound control function according to an embodiment of the present invention, and FIG. 2 is a block diagram illustrating the configuration of the portable terminal according to an embodiment of the present invention. More particularly, FIG. 1A is a side view of the portable terminal according to an embodiment of the present invention, FIG. 1B is a front view of the portable terminal, FIG. 1C is a rear view of the portable terminal, FIG. 1D is a side view of the portable terminal which has been slid, FIG. 1E is a front view of the portable terminal which has been slid, and FIG. 1F is a perspective view of the portable terminal.

Referring to FIGS. 1A to 1F and FIG. 2, a portable terminal 100 having an automatic sound control function according to an embodiment of the present invention includes a side-type one side portion (i.e., front assembly) 100A, and another side portion (i.e., rear assembly) 100B, which can slide up and down while being in close contact with the front assembly 100A. The front assembly 100A includes a display unit 120 for providing a screen according to the use of the portable terminal 100, an input unit 130 receiving a user input to control each function of the portable terminal 100, and a front case surrounding the display unit 120, input unit 130, etc. The rear assembly 100B includes a region having an opening formed at one portion thereof and a speaker (SPK) provided at a portion under the opening, a region for seating a battery for supplying power to the portable terminal 100, a rear case surrounding the speaker, the battery, etc., and a stand 101 for supporting the portable terminal 100 at a predetermined angle. The portable terminal 100 of the present invention is constructed in such a sliding manner that the front assembly 100A and rear assembly 100B can slide along each other, in which when the rear assembly 100B is in a non-slid state on the front assembly 100A, a speaker region formed on one side portion of the rear assembly 100B is covered by one side portion of the front assembly 100A. In contrast, when the rear assembly 100B is in a slid state on the front assembly 100A, the entire or a part of the speaker region is exposed to the outside.

Meanwhile, as shown in FIG. 2, when the portable terminal 100 according to an embodiment of the present invention corresponds to a mobile terminal, the portable terminal 100 includes a radio frequency (RF) unit 110 for forming a communication channel, a display unit 120, an input unit 130, an audio processing unit 140 for reproducing and outputting a sound through the speaker, a terminal-state sensing unit 150 for sensing a change in the state of the portable terminal 100, a memory 170 for storing application programs required for the operation of the portable terminal 100 and data generated according to the use of the portable terminal 100, and a controller 160 for controlling each component of the portable terminal 100. Each component of the portable terminal 100 may be disposed either in the front or rear case or on one portion thereof.

According to the portable terminal 100 having above construction, when the state (e.g., the operational state or appearance state) of the portable terminal 100 changes while the terminal-state sensing unit 150 is monitoring whether the state of the portable terminal 100 changes, the terminal-state sensing unit 150 notifies the controller 160 of the state change, then the controller 160 changes the gain and Q value (i.e., frequency bandwidth value) for an audio signal to be reproduced depending on the state change in the portable terminal 100, so that the audio signal can be output with high sound quality.

In operation, the RF unit 110 performs a series of communication processes related to portable telephone communication, a short message service (SMS), multimedia messaging service (MMS) or data communication, when the portable terminal 100 functions as a mobile terminal. To this end, the RF unit 110 includes an RF transmitter and an RF receiver, in which the RF transmitter up-converts the frequency of a signal to be transmitted and amplifies the converted signal, and the RF receiver low-noise amplifies a received signal and down-converts the frequency of the received signal.

Particularly, the RF unit 110 according to the present invention can establish a mobile communication channel with a mobile communication system and can download an audio file Ad_F through the established mobile communication channel.

The display unit 120 displays information, e.g., information about a menu and a generated audio signal, which has been input or provided by the user, as well as various menus of the portable terminal 100. Also, the display unit 120 may display a menu screen required for the communication connection of the portable terminal 100, and may display a predetermined image corresponding to a communication connection process. The display unit 120 may include a liquid crystal display (LCD). When the LCD is realized in a touch screen scheme, the display unit 120 may be included in an input means. If the input unit 130 has no keypad, the display unit 120 may output an image corresponding to a keypad at one portion thereof, recognize key values according to each touch event, and generate a predetermined key signal according to a selection event appointing a predetermined region displayed on the screen by means of function keys of the input unit 130.

When the input unit 130 is not equipped with a keypad, a plurality of function keys, for example, multiple direction keys, multiple press keys, and hot keys provided on one side of the portable terminal, may be utilized to generate key signals. Also, when the input unit 130 has no keypad, an image corresponding to a keypad may be displayed on the display unit 120 so that each event generated from a touch screen of the display unit 120 can correspond to a key signal. Meanwhile, when the input unit 130 includes a keypad, the key pad contains numeral, letter and/or function keys for inputting numeral and letter information and setting various functions. The input unit 130 generates a key signal corresponding to each key input for selecting an audio reproduction application AD_APP or audio file Ad_F which has been stored in the memory 170, and transfers the generated key signal to the controller 160.

The audio processing unit 140 reproduces an audio signal output when an audio file Ad_F stored in the memory 170 is reproduced, and transfers an audio signal, such as voice, input from a microphone (MIC) to the controller 160. Also, audio processing unit 140 reproduces various audio signals received by the RF unit 110 and outputs the audio signals through the speaker.

The terminal-state sensing unit 150 senses a change in the state of the portable terminal 100, that is, a change in the operation sate or appearance state thereof. When the portable terminal 100 is a sliding-type terminal, the terminal-state sensing unit 150 checks a slid state of the portable terminal 100. That is, the terminal-state sensing unit 150 checks whether the portable terminal 100 is in a slid state, in which the front and rear cases have been slid so that they are apart from each other by a predetermined distance, or in a non-slid state, in which the front and rear cases are aligned with each other while facing each other with the same area, then transfers the result of the checking to the controller 160.

In order to check whether the portable terminal 100 is slid, the terminal-state sensing unit 150 may use various sensor elements, such as a switch installed along the front and rear cases, optical sensors which are installed on one portion of each of the front and rear cases so as to face each other, etc. That is, any sensor element capable of detecting whether or not the front and rear cases are slid to be apart from each other can be used as the terminal-state sensing unit 150. In this case, preferably, considering the characteristics of the portable terminal 100 frequently used by the user, the terminal-state sensing unit 150 is configured to recognize a state in which the front and rear cases have been slid in relation to each other so as to be spaced a predetermined distance or more from each other, as a valid terminal state change.

The memory 170 stores application programs required for the functional operation according to an embodiment of the present invention, user data created by the user, etc. The memory 170 may roughly include a program region and a data region.

The program region stores an operating system (OS) required for booting the portable terminal 100, an audio reproduction application AD_APP required for reproducing an audio signal, application programs required for functions of the portable terminal 100, e.g., a camera function, a sound reproduction function, and an image or moving-picture reproduction function, etc. When each of the functions is activated according to a user's request, the portable terminal 100 provides a corresponding function by means of a corresponding application program under the control of the controller 160.

The data region stores data generated according to the use of the portable terminal 100. In detail, the data region may store an audio file Ad_F downloaded from the exterior, an audio file Ad_F obtained through other various methods, user data related to various functions (e.g., an image or moving-picture photographed by the aforementioned camera function, phonebook data and corresponding contents), and/or information corresponding to the user data.

The controller 160 controls the entire operation of the portable terminal 100, and a signal flow between the components of the portable terminal 100. The controller 160 may include a MODEM function and/or a CODEC function.

Particularly, the controller 160 performs a control operation so as to output audio file Ad_F created by selectively applying correction data (for example, a gain value and a correction value, e.g., a Q value (frequency bandwidth value)), which has been set in a CODEC, depending on a terminal state value received from the terminal-state sensing unit 150. That is, when the terminal is in an open state through sliding of the front or rear assembly, the controller 160 controls an audio file Ad_F to be reproduced based on an equalizer table including a first gain value and a first Q value. In contrast, when the portable terminal 100 is in a closed state through sliding of the front or rear assembly, the controller 160 controls an audio file Ad_F to be reproduced based on an equalizer table including a second gain value and a second Q value, other than the first gain value and first Q value.

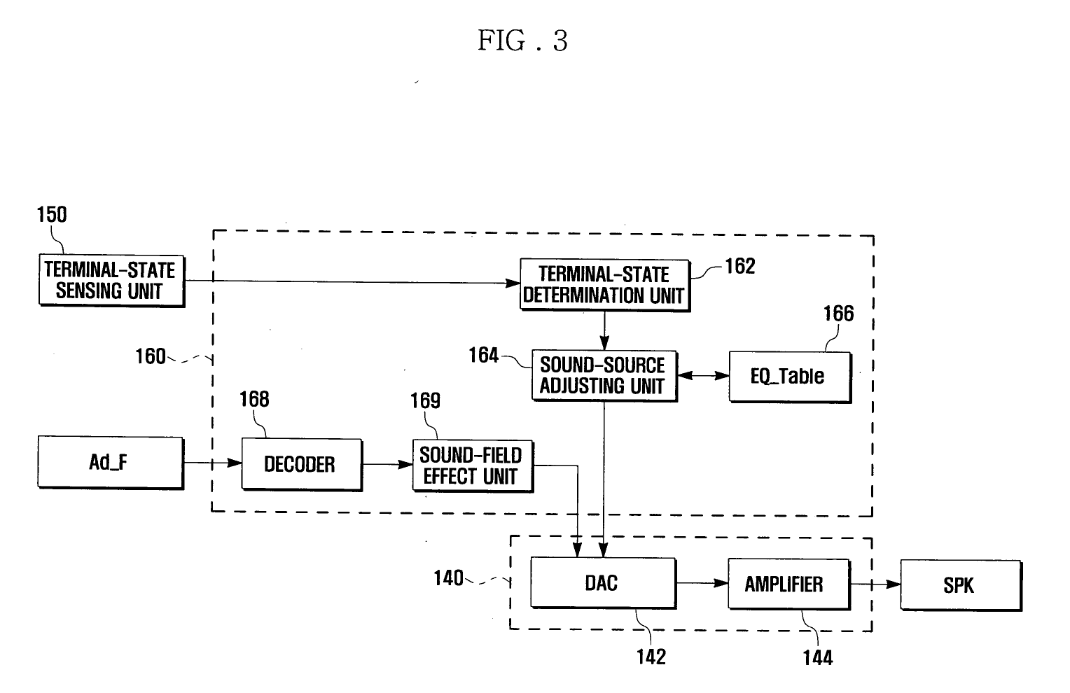

Hereinafter, a detailed construction for the automatic sound control function of the portable terminal according to an embodiment of the present invention will be described with reference to FIG. 3.

FIG. 3 is a detailed block diagram illustrating the construction of an apparatus for the automatic sound control function of the portable terminal according to an embodiment of the present invention.

Referring to FIG. 3, the controller 160 of the present invention may include a decoder 168, a sound-field effect unit 169, a terminal-state determination unit 162, a sound-source adjusting unit 164, and an equalizer table 166. The decoder 168 decodes an audio file Ad_F. The sound-field effect unit 169 provides a sound-field effect to the decoded audio file. The terminal-state determination unit 162 receives a terminal state value transferred from the terminal-state sensing unit 150 and determines the state of the portable terminal 100 based on the received terminal state value. The sound-source adjusting unit 164 controls the audio processing unit 140, which converts an audio file Ad_F into an analog signal, depending on a terminal state determined by the terminal-state determination unit 162, so that the audio processing unit 140 can apply the gain and Q value according to the terminal state. The equalizer table 166 pre-stores equalizer values and Q values corresponding to terminal states, and provides the stored equalizer values and Q values to the sound-source adjusting unit 164. The audio processing unit 140 includes a digital-to-analog converter 142 for converting a digital signal transferred from the controller 160 into an analog signal, and an amplifier 144 for amplifying the converted analog signal. Also, the audio processing unit 140 is provided at one portion thereof with the speaker for outputting the amplified signal. Meanwhile, the decoder 168 and sound-field effect unit 169 may be included in the audio processing unit 140, in place of the controller 160. Also, the equalizer table 166 may be stored in the memory 170 so as to be activated and used according to a selection of the controller 160.

The terminal-state sensing unit 150 checks whether the portable terminal 100 is in a slid state or a non-slid state by means of a switch, an optical sensor, etc. Also, the terminal-state sensing unit 150 may check whether the speaker region is in a state covered by an external case or in an exposed state by disposing a proper sensor in the speaker region of the portable terminal 100.

The terminal-state determination unit 162 determines a state of the portable terminal 100 based on a terminal state value received from the terminal-state sensing unit 150. That is, the terminal-state determination unit 162 determines whether the portable terminal 100 is in a slid state or in a non-slid state, and transfers a state value resulting from the determination to the sound-source adjusting unit 164.

The sound-source adjusting unit 164 selects a gain value and a Q value, which will be applied to an audio file Ad_F, based on the state value received from the terminal-state determination unit 162. In this case, the sound-source adjusting unit 164 determines the gain value and Q value by using the equalizer table 166.

The sound-field effect unit 169 provides a sound-field effect to the decoded audio file Ad_F. The sound-field effect changes the audio file Ad_F so that when the decoded audio file Ad_F is output, the decoded audio file Ad_F can have an effect as if the decoded audio file Ad_F is output in a virtual space, e.g., in a bathroom, an office, a subway train, a bus, a tax, a concert hall or a cave. For example, the sound-field effect unit 169 may create a sound-field effect by controlling a specific function of an audio file Ad_F, and a coefficient value applied to the function, a feedback value, an echo effect, etc. The sound-field effect unit 169 is a component for supporting the sound-field effect, and may be excluded if the portable terminal 100 does not support such a function.

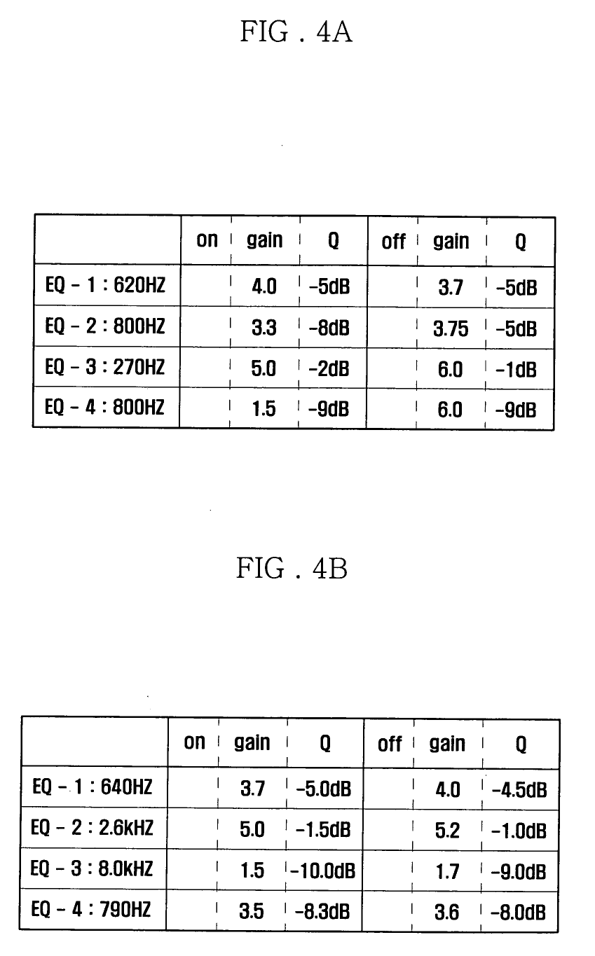

As shown in FIGS. 4A and 4B, the equalizer table 166 is a preset table in which gain values and Q values to be applied for each of a slid state (i.e., On state) and for a non-slid state (i.e., Off state) have been stored corresponding to various equalizer values. Such an equalizer table 166 may be set by collecting and analyzing audio signals output through a reproduction of an actual audio file Ad_F after the external shape of the portable terminal 100 has been manufactured. That is, the values in the equalizer table 166 may be set in such a manner that audio signal values output while an audio file Ad_F is being reproduced in a slid state (i.e., On state) are collected and analyzed, and gain values and Q values of the audio file Ad_F for reproduction in a non-slid state (i.e., Off state) are adjusted based on the result of the analysis so that the same audio signals as those reproduced in the slid state may be reproduced in the non-slid state. Also, the equalizer table 166 may be established by setting gain values and Q values for the slid state (On state) based on the non-slid state (Off state). The equalizer table 166 may include a plurality of equalizer steps, for example, first to fourth equalizer steps EQ-I to EQ-4, and different gain values and Q values depending on each equalizer step may be established according to each of the slid state (On state) and the non-slid state (Off state). While the present invention is described about a case in which the equalizer table is established by dividing the operation states of the portable terminal 100 into only the slid state (On state) and non-slid state (Off state), the present invention may employ another equalizer table which has stored more kinds of gain values and Q values based on slid degrees of the portable terminal 100. That is, it is possible to set and employ gain values and Q values applicable to an intermediate state between the slid state (On state) and the non-slid state (Off state), for example, to a half-slid state.

The digital-to-analog converter 142 converts the audio file Ad_F, which has been decoded and provided with the sound-field effect, into an analog signal by applying a gain value and a Q value, which have been appointed by the sound-source adjusting unit 164. Then, the audio file Ad_F, to which the gain value and Q value has been applied by the digital-to-analog converter 142, is amplified though the amplifier 144.

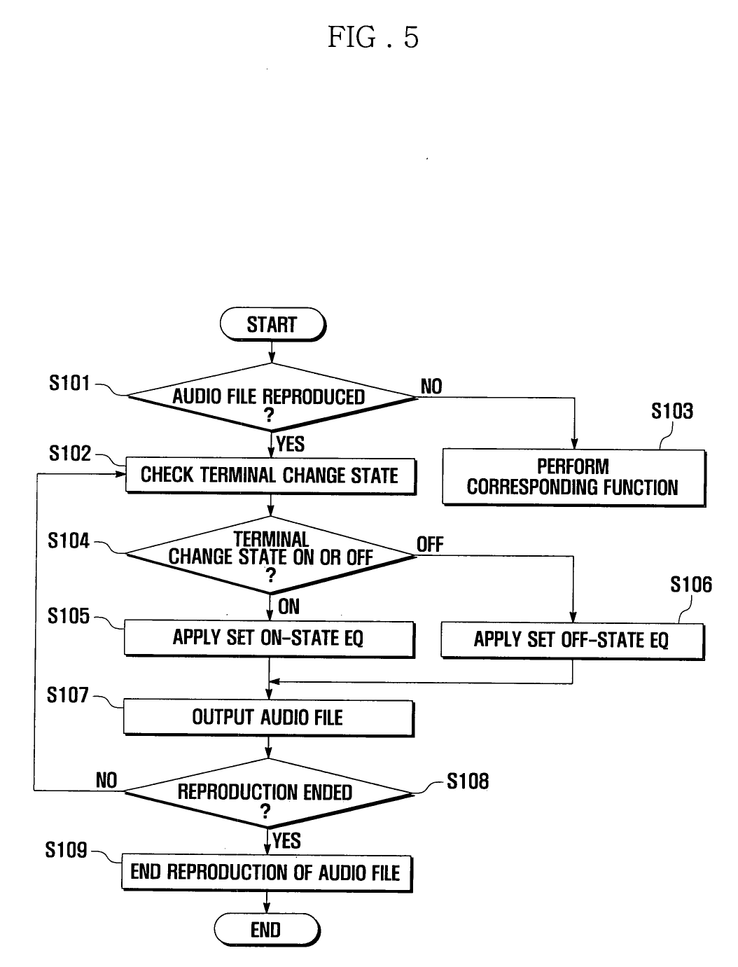

The above description has been given about the components of the portable terminal having the automatic sound control function according to an embodiment of the present invention. Hereinafter, an automatic sound control method of a portable terminal according to an embodiment of the present invention will be in detail with reference to FIG. 5.

FIG. 5 is a flowchart illustrating an automatic sound control method of a portable terminal according to an embodiment of the present invention.

Referring to FIG. 5, according to the automatic sound control method, first, the controller 160 determines if an audio file Ad_F is being reproduced (step 101). When it is determined in step 101 that an audio file Ad_F is being reproduced, the controller 160 checks a terminal state of the portable terminal 100 (step 102).

In step 101, the controller 160 proceeds to step 102 based on a signal corresponding to a user input, that is, an input for activation of an audio reproduction application AD_APP necessary for the reproduction of an audio file Ad_F and for selection/reproduction of the audio file Ad_F. When it is determined in step 101 that any audio file Ad_F is not being reproduced, the controller 160 causes the portable terminal 100 to perform a corresponding function (step 103). In this case, the corresponding function may include various functions including a communication connection function, a game function and a camera function, etc.

In step 102, the terminal-state sensing unit 150 may check whether the portable terminal 100 is in a slid state or in a non-slid state. Also, in step 102, the terminal-state sensing unit 150 may check whether the speaker region of the portable terminal 100 is covered by an external case or is exposed to the exterior by using a proper sensor installed in the speaker region.

Next, the controller 160 determines a current terminal state of the portable terminal 100 by using a terminal state value received from the terminal-state sensing unit 150 (step 104), and applies a gain value and a Q value corresponding to the slid state (On state) to the reproduced audio file Ad_F when the portable terminal 100 is in the slid state (step 105).

In step 104, the controller 160 determines whether the received terminal state value corresponds to the slid state (On state) or to the non-slid state (Off state) by means of the terminal-state determination unit 162, and transfers information about the determined state to the sound-source adjusting unit 164. The sound-source adjusting unit 164 identifies a currently-set equalizer step, and selects a gain value and a Q value which correspond to the terminal state value of the portable terminal 100 in the identified equalizer step from the equalizer table 166. Then, the sound-source adjusting unit 164 transfers the selected gain value and Q value to the audio processing unit 140.

In step 105, the controller 160 controls the audio processing unit 140 to convert the audio file Ad_F, which has been converted by the decoder 168 and sound-field effect unit 169 and has been transferred to the digital-to-analog converter 142, into an analog signal by applying the gain value and Q value selected by the sound-source adjusting unit 164.

Meanwhile, when it is determined in step 104 that the portable terminal 100 is in the non-slid state (Off state), the controller 160 controls the sound-source adjusting unit 164 to select a gain value and a Q value which correspond to the non-slid state (Off state) (step 106).

In step 106, the sound-source adjusting unit 164 identifies a currently-set equalizer step, then selects a gain value and a Q value which correspond to the non-slid state (Off state) of the identified equalizer step from the equalizer table 166. Thereafter, the sound-source adjusting unit 164 transfers the selected gain value and Q value to the digital-to-analog converter 142 of the audio processing unit 140.

Next, the controller 160 controls the audio processing unit 140 to output the audio file Ad_F, to which the gain value and Q value have been applied, through the speaker (step 107).

In step 107, the audio processing unit 140 amplifies the audio file Ad_F, to which the gain value and Q value have been applied and which have been converted into an analog signal, by means of the amplifier 144, then transfers the amplified signal to the speaker. The speaker outputs the amplified audio file Ad_F as an audio signal according to a corresponding voltage.

Next, the controller 160 determines if an event, for example, a key input signal for ending the reproduction of the audio file Ad_F, is received (step 108), and ends the reproduction of the audio file Ad_F if the event for ending is generated (step 109). Meanwhile, it is determined in step 108 that there is no event for ending of the reproduction, the controller 160 returns to step 102, in which the controller 160 controls the terminal-state sensing unit 150 to check the state of the portable terminal 100.

As described above, the automatic sound control apparatus and method of the portable terminal according to an embodiment of the present invention adjusts correction values, e.g., a gain value and a Q value, to be applied to an audio file Ad_F depending on the state of the portable terminal 100, that is, depending on the slid state (On state) and non-slid state (Off state) of the portable terminal 100, so that it is possible to output an audio signal with optimal sound quality.

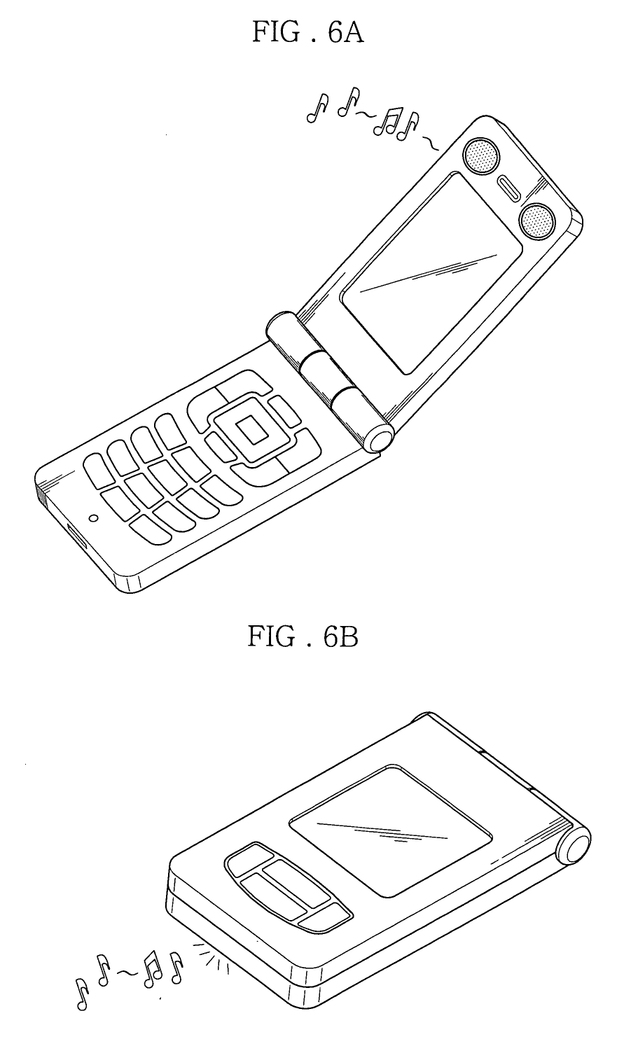

FIGS. 6A and 6B are perspective views illustrating the appearance of a folder-type portable terminal to which the automatic sound control method according to an embodiment of the present invention can be applied.

Referring to FIGS. 6A and 6B, when a folder of the folder-type portable terminal, to which the present invention is applied, is opened, the folder-type portable terminal outputs an audio file through a speaker after applying, to the audio file, a correction value, i.e., a gain value and a Q value, according to the open state. Also, when a speaker region of the portable terminal has been covered by an external case, that is, when the portable terminal has been folded, the portable terminal outputs an audio file through the speaker after applying a correction value according to the folded state to the audio file. Selecting and applying gain and Q values upon reproduction of an audio file in the folder-type portable terminal are similar to those in the sliding-type portable terminal, so a detailed description thereof will be omitted to avoid redundancy. When the automatic sound control apparatus and method of the present invention is applied to the folder-type portable terminal, a terminal-state sensing unit may be installed at one portion of external cases, which face each other in a folded state. Otherwise, a terminal-state sensing unit may be disposed in a hinge portion so that a controller can regard rotation by a predetermined angle or more as a change in the terminal state of the portable terminal and can apply the change to a terminal state value.

Meanwhile, while the automatic sound control apparatus and method according to the present invention have been described about sliding-type and folder-type portable terminals as examples, the present invention is not limited thereto. In other words, the automatic sound control apparatus and method according to the present invention can be applied in the same way to any portable terminal having such a structure that the speaker region of the portable terminal is either covered or exposed depending on a change in the state of the portable terminal. For example, the automatic sound control apparatus and method according to the present invention can be applied in the same way, even to a display-rotation-type portable terminal which has such a structure that the speaker thereof is provided in one portion of an external case so that the entire or a part of the speaker is covered or exposed, depending on a change in the state of the external case.

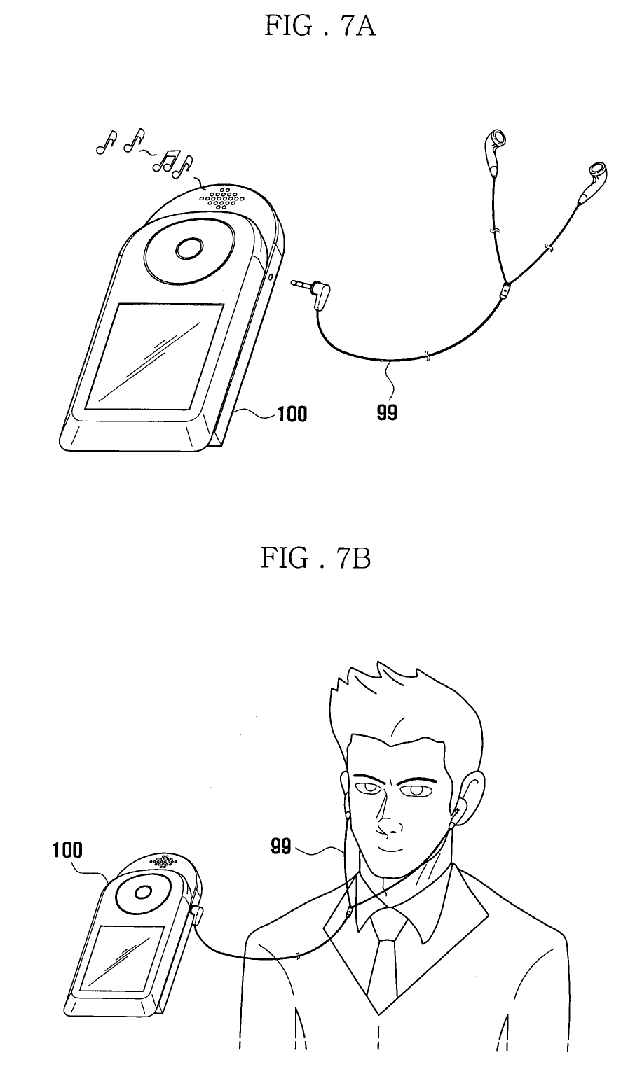

FIGS. 7A and 7B are views illustrating a case in which the automatic sound control method is applied to a portable terminal and a peripheral device according to an embodiment of the present invention.

It should be noted that, although the following description will be given about an earphone as a peripheral device connected to a portable terminal, the present invention is not limited thereto. That is, it should be understood that the peripheral device in the present invention includes various devices, containing a headset and a separate auxiliary speaker, as well as an earphone, which can be connected to the portable terminal and can reproduce sound.

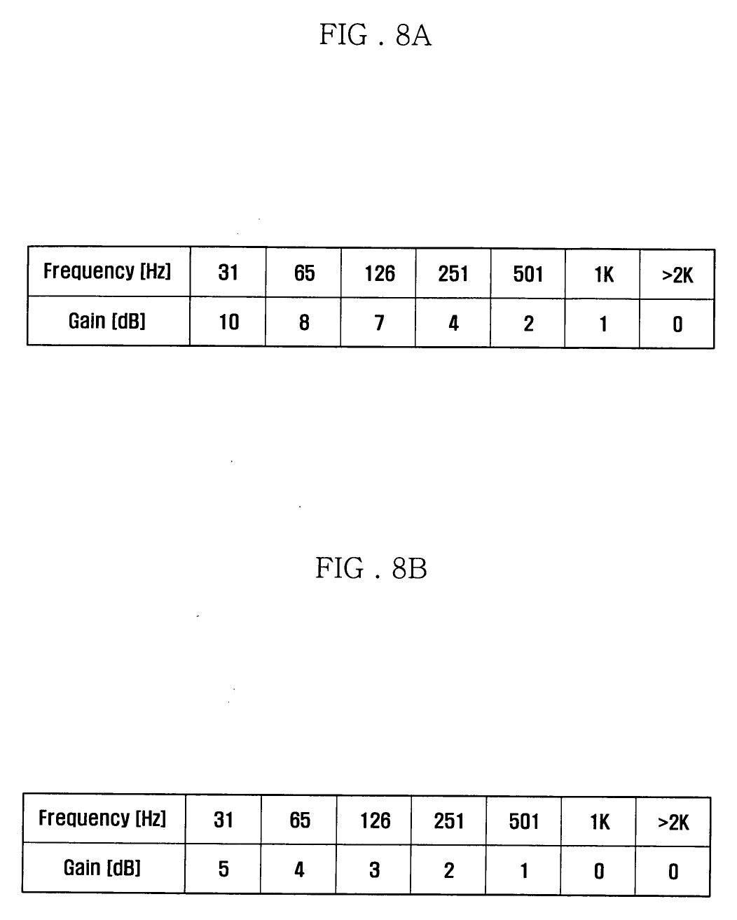

Referring to FIGS. 7A and 7B, according to the automatic sound control method applied to a portable terminal 100 and a peripheral device based on the present invention, when the peripheral device, e.g., an earphone 99, is not connected, a sound source is corrected according to a change in the operation state of the portable terminal 100 by means of an equalizer table as shown in FIG. 4. In contrast, when the earphone 99 is connected, a sound source is corrected by means of a new sound-source correction table as shown in FIGS. 8A and 8B, and is then transmitted to the earphone 99.

In detail, the portable terminal 100 may apply different equalizer tables, which store different gain values and different Q values, depending on a change in the operation state of the portable terminal, i.e., depending on whether or not the earphone 99 is connected to the portable terminal. In other words, when the earphone 99 is not connected to the portable terminal 100, the portable terminal 100 may perform a control operation to correct a sound source by applying correction data including a corresponding gain value and Q value according to a slid state, a non-slide state and a half-slid state, and to output the corrected sound source. In contrast, when the earphone 99 is connected to the portable terminal 100, the portable terminal 100 may correct a sound source by applying a new equalizer table as shown in FIGS. 8A and 8B and transmit the corrected sound source to the earphone 99. While the equalizer table of FIGS. 8A and 8B shows a change of only a gain value, correction data for Q value may be selectively added to the equalizer table. Also, the equalizer table may include various gain values according to frequencies in consideration of expansibility of user selection.

As described above, according to the automatic sound control apparatus and method and the portable terminal using the same based on the present invention, an audio signal can be optimized according to the state of a portable terminal before being output, regardless of the external shape of the portable terminal and the location of an equipped speaker.

While exemplary embodiments of the present invention have been shown and described in this specification, it will be understood by those skilled in the art that various changes or modifications of the embodiments are possible without departing from the spirit and scope of the invention as defined by the appended claims. Accordingly, the scope of the invention is not to be limited by the above embodiments but by the claims and the equivalents thereof.

What is claimed is:

1. An automatic sound control method comprising:
detecting a change in an operation of a portable terminal upon reproduction of an audio file;
correcting an audio file according to the change in the operation of the portable terminal; and
outputting the corrected audio file.

2. The method of claim 1, wherein the detecting step comprises checking if either an entire or a part of a speaker region of the portable terminal is in a covered state or in an exposed state.

3. The method of claim 2, wherein the correcting step comprises:
determining if the speaker region of the portable terminal is in the exposed state or in the covered state;
reading a table which has stored data corresponding to each of the exposed and covered states of the speaker region;
establishing sound source correction data corresponding to the determined state based on the table; and
correcting the audio file based on the established sound source correction data.

4. The method of claim 3, wherein the established sound source correction data is applied to the audio file in such a manner that a gain value and a frequency band, which have been established as the sound source correction data, are set as a gain value and a frequency band of the audio file, which has been decoded, provided with a sound-field effect and converted into an analog signal.

5. The method of claim 4, wherein the outputting the audio file to which the sound source correction data has been applied comprises:
amplifying the audio file with the corrected gain value and frequency band; and
outputting the amplified audio file through a speaker.

6. The method of claim 1, wherein the detecting step comprises detecting whether the portable terminal is in a slid state or in a non-slid state.

7. The method of claim 1, wherein the detecting step comprises detecting whether a folder of the portable terminal is in an open state or in a closed state.

8. The method of claim 1, wherein the detecting step comprises detecting whether there has been relative rotation between two side portions of the portable terminal.

9. The method of claim 1, wherein the detecting step comprises detecting whether or not a peripheral device is connected to the portable terminal.

10. The method of claim 9, wherein the peripheral device includes at least one selected from the group consisting of an earphone, a headset and an auxiliary speaker.

11. An automatic sound control apparatus comprising:
a terminal-state sensing unit for detecting a change in an operation of a portable terminal;
a controller for setting different sound source correction data depending on the change in the operation; and
an audio processing unit for applying the sound source correction data to the audio file and outputting the audio file.

12. The apparatus as claimed in claim 11, wherein the terminal-state sensing unit detects if either an entire or a part of a speaker region of the portable terminal is in a covered state or in an exposed state.

13. The apparatus as claimed in claim 12, wherein the terminal-state sensing unit detects whether the portable terminal is in a slid state or in a non-slid state.

14. The apparatus as claimed in claim 12, wherein the terminal-state sensing unit detects whether a folder of the portable terminal is in an open state or in a closed state.

15. The apparatus as claimed in claim 12, wherein the terminal-state sensing unit detects whether there has been relative rotation between two side portions of the portable terminal.

16. The apparatus as claimed in claim 11, wherein the terminal-state sensing unit detects whether or not a peripheral device is connected to the portable terminal.

17. The apparatus as claimed in claim 16, wherein the peripheral device includes at least one selected from the group consisting of an earphone, a headset and an auxiliary speaker.

18. The apparatus as claimed in claim 11, wherein the controller comprises:
a terminal-state determination unit for determining a terminal state of the portable terminal based on terminal state data sensed by the terminal-state sensing unit; and
a sound-source adjusting unit for selecting different sound source correction data depending on the terminal state of the portable terminal.

19. The apparatus as claimed in claim 18, further comprising at least one selected from the group consisting of:
a table for storing each sound source correction data item corresponding to the terminal state;
a decoder for decoding the audio file; and
a sound-field effect unit for adding a sound-field effect to the decoded audio file.

20. The apparatus as claimed in claim 19, wherein the audio processing unit comprises:
a digital-to-analog converter for converting the audio file, which has been decoded by the decoder and then to which a sound-field effect has been selectively added, into an analog signal according to the sound source correction data; and
an amplifier for amplifying the analog signal.

21. The apparatus as claimed in claim 19, wherein, in the table, different gain values and different frequency bandwidths are set depending on a change in the terminal state of the portable terminal and on equalizer steps.

22. The apparatus as claimed in claim 11, further comprising:
a memory for storing the audio file;
an input unit for generating an input signal required to select the audio file stored in the memory and to reproduce the selected audio file;
a display unit for displaying a screen according to the selection and reproduction of the audio file; and
a radio frequency unit for receiving the audio file from an exterior.

23. A portable terminal comprising:
a memory for storing an audio file;
a speaker for reproducing and outputting the audio file;
a controller for controlling the audio file to be reproduced and output;
one side portion including at least one of the memory, the speaker and the controller; and
another side portion including one or more components except for said at least one of the memory, the speaker and the controller, said another side portion having at least a predetermined area facing said one side portion,
wherein the speaker applies different sound source correction data to the audio file, depending on a change in the facing area between the two side portions.

24. The portable terminal as claimed in claim 23, wherein the controller establishes different sound source correction data depending on whether the speaker is exposed or covered, in order to control the reproduction of the audio file.
